(19) United States
(12) Patent Application Publication
(10) Pub. No.: US 2004/0249955 A1
(43) Pub. Date: Dec. 9, 2004

(54) Method and apparatus for passing call control application information within a network signaling protocol

(76) Inventor: Randy Wuerful, Santa Clara, CA (US)

Correspondence Address: Siemens Corporation, Attn: Elsa Keller, Legal Administrator, Intellectual Property Department, 186 Wood Avenue South, Iselin, NJ, 08830, US

(21) Appl. No.: 10/456,150

(22) Filed: Jun. 5, 2003

(51) Int. Cl. G06F 15/16

(52) U.S. Cl. 709/227

(57) ABSTRACT

A system, method, apparatus, means, and computer program code is provided for passing call control application and other information within a network using a network signaling path instead of a side channel communications link or path. In some embodiments, a server application (or its associated device) can initiate a call/communication session instead of having it have to be initiated by a client device or client application. In addition, a client application can report monitored session initiation/control events to a server application via a network signaling path rather than counting on such events being reported over a separate side channel communications link.

### FIELD OF THE INVENTION

The present invention relates to a method and apparatus for passing call control application information within a network.

### BACKGROUND

In conventional communication systems, a server application may need to instruct a client device (e.g., computer, telephone) or an application operating on the client device to initiate a communications session on a network. This typically requires that the server application provide information to the client device or application regarding the session to be initiated. For example, the server application may need to tell the client application or client device to initiate a call to a specific telephone number. This information is typically provided to the client device or client application via a side channel communications path or link so that the requested action can be correlated with the session initiation actions taken by the client device or application. Thus, session initiation and control information is provided via the side channel communications link. The side channel communications link may be a dedicated signaling path established between two devices for use by applications on the devices to exchange request, response, and event information.

Unfortunately, use of such a side channel communications link has several drawbacks. First, event or status notifications can be slowed down, delayed, or even suffer delivery failure when using a side channel communications link. Second, without knowledge of the network or the network signaling protocols used on the network, the granularity of event reporting may be less specific that what is needed by the server application or a client application. For example, a client application may be able to report only a “connected” or “not connected” status to a server application, rather than an intermediate status such as “alerting”. Third, if server applications need to correlate call/communication session initiations with actions to be taken on those calls/communication session initiations, the server application may need to correlate session control instructions for the call/communication session about to be established with the client device. This requires that correlation values be provided in both the side channel control instructions and session establishment protocol signals, thereby increasing the difficulty of providing such action information.

It would be advantageous to provide a method and apparatus that overcame the drawbacks of the prior art. In particular, it would be desirable to provide a method and apparatus that facilitates passing of call control application and/or other information via a network signaling path without needing or requiring a side channel communications link.

### SUMMARY

Embodiments provide a system, method, apparatus, means, and computer program code for passing call control application and other information within a network using a network signaling path instead of a side channel communications link. In some embodiments, a server application (or its associated device) can initiate a call/communication session instead of having it be initiated by a client device or application, or create data to be sent to the client device via a network signaling path instead of via a side channel communication path. In addition, a client application can report monitored session initiation/control events to a server application via a network signaling path rather than counting on such events being reported over a separate side channel communications link.

Additional advantages and novel features of the invention shall be set forth in part in the description that follows, and in part will become apparent to those skilled in the art upon examination of the following or may be learned by the practice of the invention.

In some embodiments, a method may include application information within network signaling or via a network signaling path may include some or all of the following: a first interworking unit receiving data from a server application indicative of an action involving a client device associated with a network; the first interworking unit mapping the data into a signaling message compliant with a network signaling protocol used on the network; the first interworking unit providing the signaling message to a proxy application capable of sending the signaling message via a network signaling path; the proxy application providing the signaling message to a second interworking unit; the second interworking unit mapping the signaling message into an application language message; the second interworking unit providing the application language message to a client application associated with a client device; and the client application processing the application language message. Thus, the first interworking unit may be associated with a server and/or server application and the second interworking unit may be associated with a client device and/or client application. One or more network signaling components also may be used to facilitate network communications.

As another example, in some embodiments, a method for passing call control application information within a network signaling protocol or via a network signaling path may include some or all the following: the second interworking unit receiving data from the client application; the second interworking unit mapping the data into a signaling message; the second interworking unit providing the signaling message to the proxy application; the proxy application providing the signaling message to the first interworking unit; the first interworking unit mapping the signaling message into an application language message; the first interworking unit providing the application language message to the server application; and the server application processing the application language message.

Other embodiments may include means, systems, computer code, etc. for implementing some or all of the elements of the methods described herein.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

The accompanying drawings, which are incorporated in and form a part of the specification, illustrate the embodiments, and together with the descriptions serve to explain the principles of the invention.

FIG. 1 is a block diagram of system components for an embodiment of a system;

FIG. 2 is a flowchart of a first embodiment of a method;

FIG. 3 is a flowchart of a second embodiment of a method;

FIG. 4 is a flowchart of a third embodiment of a method;

FIG. 5 is a flowchart of a fourth embodiment of a method; and

FIG. 6 is a block diagram of potential components for a server or client device.

### DETAILED DESCRIPTION

Applicant has recognized that there is a market opportunity for systems, methods, means and computer code that facilitate passing of call control application information within a network using the session initiation and/or control signaling protocol used within the network. As a result, in some embodiments a server application (or its associated device) can initiate a call/communication session instead of requiring it to be initiated by a client device or application. Also, in some embodiments, the server application may provide data to the client device using a network signaling path instead of a side channel communication path. In addition, in some embodiments, a client application can report monitored session initiation/control events to a server application via a network signaling path rather than counting on such events being reported over a separate side channel communications link. These and other features will be discussed in further detail below, by describing a system, individual devices, and processes according to embodiments of the invention.

System

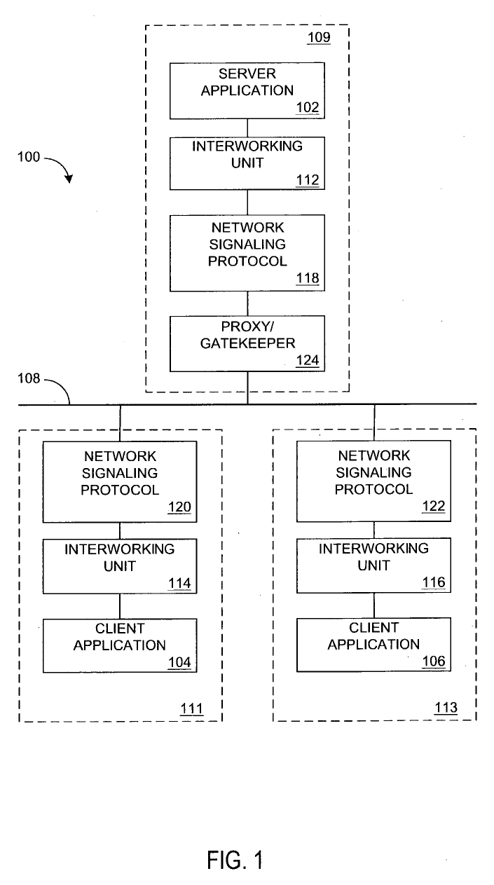

Now referring to FIG. 1, a representative system 100 is illustrated that may be used in some embodiments. The system 100 may include one or more server applications 102 that may be in communication with one or more client applications 104, 106 via a network 108.

In some embodiments, the server application 102 may be or include applications such as applications that provide interactive voice responses (IVR) to callers, collect and store messages that have been left by callers and route them to the appropriate client applications, route customer services calls made to call centers to the appropriate agent or device, authenticate callers, receive facsimile transmissions and route them to the appropriate client devices, match a customer record with a calling number and route the customer record and call to one or more client devices, etc. As another example, the server application 102 may be or include a third party call control or CTI (Computer Telephony Integration) based application. In some embodiments, the server application 102 may be installed, resident or operating on a server or other device 109 and may access, use or communicate with databases, other applications, etc.

In some embodiments, the client applications 104, 106 may be or include software, code, plug-ins, etc. installed, resident, or operating on client devices 111, 113, such as a computer, workstation, terminal, telephone, personal digital assistant (PDA), kiosk, facsimile machine, point-of-sale device, etc. Thus, providing data to a client application includes providing data to the client device on which the client application is installed, resident, or operating.

In some embodiments, the client applications 104, 106 may provide or support such functions or features as instant messaging, telephone call initiation, information display, document sharing, multi-conferencing, contact list maintenance, call initiation, presence monitoring, etc. The client applications 104, 106 may communicate or interact with the server application 102 to provide additional functionality, features, etc.

In some embodiments, the network 108 may be or include such things as local area networks (LANs), the Internet, the World Wide Web, or some other public or private computer, cable, telephone, client/server, peer-to-peer, or communications network or intranet. In some embodiments, a communications network also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL connections, etc. Moreover, as used herein, communications include those enabled by wired or wireless technology.

The network 108 may use one or more network signaling protocols, such as H.323, SIP (Session Initiation Protocol) for control signaling and session initiation between applications and/or devices in the system 100. Other protocols (e.g., TCP/IP) also may be used in the network 108. In addition, one or more side channel communication links or paths via the network 108 may be established between devices in the system 100. Such side channels may use other protocols (e.g., HTML) to facilitate communication.

The system 100 also includes server side interworking unit 112 and client side interworking units 114, 116, network signaling protocol components 118, 120, 122, and proxy/gatekeeper 124 (also referred to herein as a “proxy application”). The term “interworking unit” is used herein for convenience purposes only and no specific limitations or restrictions are intended by use of the term “interworking unit”.

In some embodiments, the interworking unit 112 may be or include software, code, plug-in, etc. operating on the same device 109 as the server application 102. In other embodiments, the interworking unit 112 may be or include software, code, plug-in, etc. operating on a different device while being in communication with the server application 102. In a similar fashion, in some embodiments, the interworking units 114, 116 may be or include software, code, plug-in, etc. operating on the same devices as the client applications 104, 106, respectively. In other embodiments, the interworking units 114, 116 may be or include software, code, plug-in, etc. operating on different devices while being in communication with their respective client applications 104, 106.

The network signaling protocol component 118 receives or otherwise obtains data from the interworking unit 112 and encompasses or uses such data in one or more communications compliant with the network signaling protocols used on the network 108. Thus, the network signaling protocol component 118 may format, monitor, or otherwise facilitate communications to and from the network 108. In some embodiments, the network signaling protocol component 118 may be software or other code operating on the same device 109 as the server application 109. For example, network signaling protocols such as H.323 and SIP provide the capability to carry user or application (e.g., server application 102) data in FACILITY messages (in the case of the H.323 protocol) or INFO messages (in the case of SIP).

Once the interworking unit 112 has created the appropriate message, it can send or otherwise provide the message to the proxy application 124 via the network signaling component 118. The proxy application 124 then forwards the message to the appropriate client device (e.g., the client device 111). In some embodiments, the proxy application 124 may be or include software, code, plug-in, etc. operating on the same device 109 as the server application 102.

When the client device 111 receives or otherwise obtains the message from the proxy application 124, the interworking unit 114 extracts the information from the message that was created by the interworking unit 112 and provides the information to the client application 104. The message may first pass through the network signaling protocol component 120, which may operate in a manner similar to the network signaling protocol component 118. The client application 104 then can act accordingly based on the information.

As one example of the process discussed above, the server application 102 may issue a “sendMessage(foobar)” command to the client application 104. The interworking unit 112 may map this command to an INFO[sendMessage(foobar)] using the SIP INFO procedure and send the INFO message to the proxy application 124 via the network signaling protocol component 118 (which might be or include a SIP signaling component). The proxy application 124 then forwards or otherwise sends the INFO[sendMessage(foobar)] message to the client device 111. The interworking unit 114 receives the INFO[sendMessage(foobar)] message via the network signaling protocol component 120 (which might also be or include a SIP signaling component), extracts out “[sendMessage(foobar)]”, and provides the “[sendMessage(foobar)]” message to the client application 104. The client application 104 processes the “[sendMessage(foobar)]” message and causes the client device 111 to display the message “foobar”. The same type of example also could be performed using the H.323 protocol, where the SIP INFO messages are replaced with H.323 FACILITY messages and the proxy application 124 is functioning as an H.323 gatekeeper. The network signaling protocol components 118, 120 also then act to support H.323 compliant communications.

As illustrated by the example above, the interworking unit 112 may interface the server application 102 to the session and control signaling protocols used within the network 108. More specifically, the interworking unit 112 may receive data from the server application 102 indicative of an action or event the server application 102 wishes to implement, be made aware of, etc. The interworking unit 112 can convert or translate the data from the server application 102 for transmission via a network signaling protocol (e.g., H.323, SIP) and network signaling path to the appropriate client application.

As another way of looking at the function of the interworking unit 112, the interworking unit 112 may map commands or requests received from the server application 112 into actions to be done in the network or other messages that can be communicated via regular network signaling paths instead of using side channel communication links. In this way, the server application 102 is independent of the network 108 and the signaling or control protocols used within the network 108 and the interworking unit 112 has the knowledge of the network 108 needed to communicate commands, requests, data, etc. from the server application 102 to client applications 104, 106 via network signaling paths. The server application 102 does not need to use a side channel communications link or path to communicate the information to the desired client application or client device. Thus, the interworking unit 112 helps facilitate passing of call control application information from the server application 102 to the client applications 104, 106 or their respective client devices 111, 113 within a communication compliant with the network signaling protocol used by the network 108.

By using the communications within a network signaling protocol and network signaling path, the server application 102 does not need to communicate with the client applications 104, 106 via a side channel communications link or path. As a more specific example, the interworking unit 112 may provide caller data to the network signaling protocol component 118 regarding a particular call initiated by the server application 102. The server application 102 may be initiating a call to the client device 111 (e.g., a computer, telephone, two way pager, PDA) on which the client application 104 resides or is operating. Typically, the server application 102 would provide such caller information to the client application 104 or client device 111 via a side channel communication link. The server application 102 can provide the caller data to the interworking unit 112 along with any call initiation information that may be needed to initiate the call to the client device 111. The interworking unit 112 can process the caller data and provide the caller data and the call initiation information via the network signaling protocol component 118 and create a communication carrying both the caller data and the call initiation information that is compliant with the session initiation and network signaling protocol used on the network 108. The caller data will be associated with the call initiation information since they are carried as part of the same single or group of communications.

The interworking unit 114 may receive the caller data and the call initiation information via the network signaling protocol component 120 and network signaling path, extract the necessary information, and provide the information to the client application 104. Thus, the client application 104 does not need to have knowledge of the protocols used on the network 108.

The call initiated by the server application 102 may have a call reference value or other identifier associated with it. Thus, if the server application 102 wishes to send later data or other messages to the client application 104 that are related to the same call, the data can be associated with the same call reference value or other identifier so that the client application 104, upon receiving the later data or other message, knows what call they should be applied to or used with.

As another example of how the interworking units 112 and 114 may facilitate passing of information, when, for example, the client application 104 or the client device 109 on which the client application resides or is operating creates an alert or other message, the alert or other message may be transmitted to the proxy application 124. The alerts or other messages may be created as part of monitored session initiation/control events and the server application 102 may want to have such event information reported to it. Thus, the events can be reported to the server application 102 via the network signaling path as opposed to a side communications link or path. Representative alerts or messages include ringing alerts, call muting alerts, call forwarding related alerts, etc.

The proxy application 124 may be programmed or established with instructions on how to handle alerts or messages when they are received from a client application or client device. For example, the server application 102 may want to know each time the proxy application 124 gets data regarding an alert or other message generated by the client application 104 or its associated client device, and the proxy application 124 may be programmed accordingly. As a result, when the proxy application 124 receives such a message or alert, the proxy application 124 may send a communication to the interworking unit 114 regarding such alert or message. The interworking unit 114 then can map the information from the alert or message into data for the server application 102 and provide the data to the server application 102 via a network signaling path instead of a side channel communications path.

As one example, the interworking unit 114 can process the data and provide the data to the network signaling protocol component 120 that can then create a communication carrying data that is compliant with the session initiation and network signaling protocol used on or with the network 108. The interworking unit 114 has the knowledge of the network 108 needed to communicate commands, requests, data, etc. from the client application 104 to the server application 102 via network signaling paths. The client application 104 does not need to use a side channel communications link or path to communicate the information to the server application 102.

As one example of the process discussed above, suppose the server application 102 is monitoring the client device 111. The client device 111 may initiate a SIP call to the client device 113 by sending an INVITE message to the proxy application 124. The proxy application 124 passes the INVITE message to the network signaling protocol component 118 so that the interworking unit 112 can map the INVITE message to a CSTA (Computer Supported Telephony Application) “originated” event to the server application 102. The server application 102 processes the INVITE message and passes it back to the proxy application 124 to send on to the client device 113. The client device 113 processes the INVITE message and presents a call to a user of the client device 113. A call is rung at the client device 113, which causes a “180 ringing” message to be sent to the proxy application 124. The proxy application 124 passes the “180 ringing” message to the network signaling protocol component 118 so that the interworking unit 112 can map the “180 ringing” to a CSTA “delivered” event and pass it the server application 102 or other applications that are monitoring the client devices 111 and 113. In a similar manner all subsequent SIP signaling messages relating to this call initiation can be indicated to the network signaling protocol component 118 so that the interworking unit 112 can map these messages to CSTA events, as needed.

As illustrated by this example, the interworking unit 112 maps the signaling from the SIP messages to CSTA events that can be passed to the server application 102 or other applications. In other embodiments, the interworking unit 112 can take SIP, H.323, ISDN, etc. as the signaling protocol and map the signaling protocol to relevant application CSTA, TAPI, etc. events. The same type of example also could be performed using the H.323 protocol, where the SIP INFO messages are replaced with H.323 FACILITY messages and the proxy application 124 is functioning as an H.323 gatekeeper.

Process Description

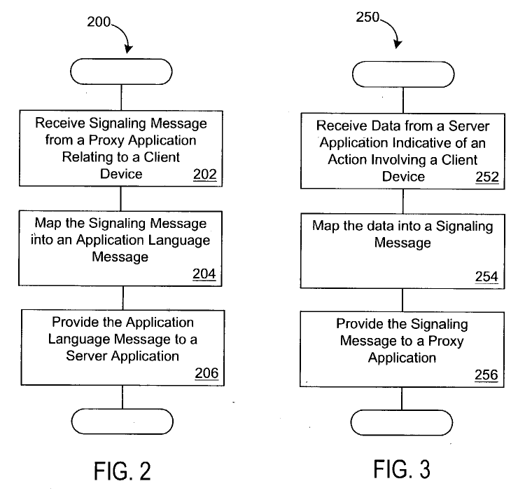

Reference is now made to FIG. 2, where a flow chart 200 is shown which represents the operation of a first embodiment of a method. The particular arrangement of elements in the flow chart 200 is not meant to imply a fixed order to the elements; embodiments can be practiced in any order that is practicable. In some embodiments, some or all of the elements of the method 200 may be performed or completed by a server side interworking unit such as the interworking unit 112, as will be discussed in more detail below. For purposes of discussion, the interworking unit 112 is assumed to be implementing the method 200.

Processing begins at 202 during which the interworking unit 112 receives or otherwise obtains a signaling communication or other message from the proxy application 124 regarding an event, alert, message, etc. associated with the client device 111. The signaling message may be compliant with the network signaling protocol used on the network 108. In some embodiments, the signaling message may include a SIP INFO message or H.323 FACILITY message received by the proxy application 124 from the client device 111, the interworking unit 114, etc.

For purposes of further explanation, such events, alerts, messages, etc. are referred to herein as “events”. The event may be a session initiation or control event occurring at the client device 111 that is reported to the proxy application 124 by the client device 111, its related client application 104, or the interworking unit 114. For example, the client application 104 may create data indicative of the event and send or otherwise provide it to the interworking unit 114 (e.g., the data may be in or be part of an application language message). The data may be part of a CSTA, TAPI, etc. event reported by the client application 104. The interworking unit 114 may map the data into the INFO or FACILITY message (e.g., the signaling message) that is received by the proxy application 124. Thus, the signaling message is sent to and received by the proxy application 124 using network signaling protocols and a network signaling path as opposed to a side channel communication path.

During 204, the interworking unit 112 maps the signaling message received from the proxy application 124 into an application language message. For example, the interworking unit 112 may map the INFO or FACILITY portions of the signaling message into a CSTA or TAPI (Telephone Application Programming Interface), etc. event message. The term “application language message” is used herein merely for purposes of convenience and no specific limitations are intended or implied by the used of such term herein.

During 206, the interworking unit 112 provides the application language message to the server application 102.

In some embodiments, the method 200 may include the proxy application 124 receiving the signaling message from the interworking unit 114, the interworking unit 114 mapping an application language message or other data into the signaling message received by the proxy application 124, the interworking unit 114 sending the signaling message, etc.

Reference is now made to FIG. 3, where a flow chart 250 is shown which represents the operation of a second embodiment of a method. The particular arrangement of elements in the flow chart 250 is not meant to imply a fixed order to the elements; embodiments can be practiced in any order that is practicable. In some embodiments, some or all of the elements of the method 250 may be performed or completed by the interworking unit 112.

Processing begins at 252 during which the interworking unit 112 receives data from a server application regarding a command, action, etc. involving a client device (e.g., the client device 111) or a client application (e.g., the client application 104). In some embodiments, an action may include an action to be taken by an application operating on the client device. Receiving data from a server application regarding an action to be taken by a client device also may include receiving data regarding a call or other type of communication session being initiated by the server application. In some embodiments, the data received from the server application 102 may be or include an application language message, e.g., be indicative of a CSTA or TAPI event.

During 254, the interworking unit 112 maps the data received from the server application 102 into a signaling message compliant with the network signaling protocol used by the network 108. For example, the signaling message may or include an INFO message using SIP or a FACILITY message using the H.323 protocol.

During 256, the interworking unit 112 provides the signaling message to the proxy application 124, which is suitable for transmittal by the proxy application 124 using a network signaling path instead of a side channel communications link or path.

In some applications, the method 250 may include the proxy application 124 providing the signaling message to the client device 111 or to another device. For example, the proxy application 124 may send the signaling message to the interworking unit 114. The interworking unit 114 may extract out the information regarding the event, command, etc., map it to an application language message, and provide the application language message to the client application 104 for processing. Thus, in some embodiments, the method 250 also may include the interworking unit 114 receiving the signaling message via a network signaling path from the proxy application, mapping the signaling message onto an application language message, and providing the application language message to the client application 104.

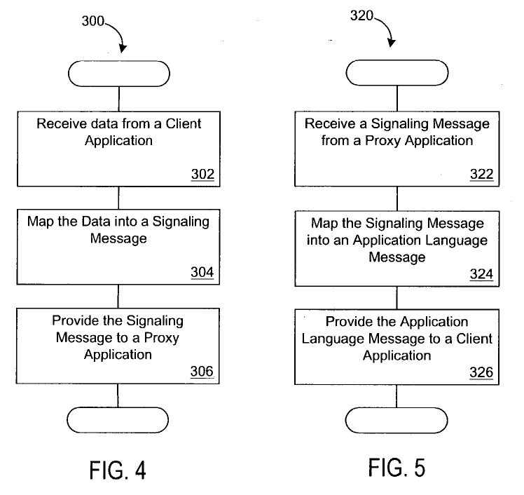

Reference is now made to FIG. 4, where a flow chart 300 is shown which represents the operation of a third embodiment of a method. The particular arrangement of elements in the flow chart 300 is not meant to imply a fixed order to the elements; embodiments can be practiced in any order that is practicable. In some embodiments, some or all of the elements of the method 300 may be performed or completed by a client side interworking unit such as the interworking unit 114, as will be discussed in more detail below. For purposes of discussion, the interworking unit 114 is assumed to be implementing the method 300.

Processing begins at 302 during which the interworking unit 114 receives data from a client application 104. In some embodiments, the data received from the client application 104 may be or include an application language message, e.g., be indicative of a CSTA or TAPI event.

During 304, the interworking unit 114 maps the data received from the server application 104 into a signaling message compliant with the network signaling protocol used by the network 108. For example, the signaling message may or include an INFO message using SIP or a FACILITY message using H.323.

During 306, the interworking unit 114 provides the signaling message to the proxy application 124 via a network signaling path instead of a side channel communications link or path.

In some applications, the method 300 may include the proxy application 124 providing the signaling message to the interworking unit 112. The interworking unit 112 may extract out the information regarding the data provided by the client application 104, map it to an application language message, and provide the application language message to the server application 102 for processing. Thus, in some embodiments, the method 300 also may include the interworking unit 114 receiving the signaling message from the proxy application 124, mapping the signaling message onto an application language message, and providing the application language message to the server application 102.

Reference is now made to FIG. 5, where a flow chart 320 is shown which represents the operation of a fourth embodiment of a method. The particular arrangement of elements in the flow chart 320 is not meant to imply a fixed order to the elements; embodiments can be practiced in any order that is practicable. In some embodiments, some or all of the elements of the method 320 may be performed or completed by the interworking unit 114.

Processing begins at 320 during which the interworking unit 114 receives a signaling communication or other message from the proxy application 124 regarding the client device 111. The proxy application 124 may send the signaling message via a network signaling path instead of a side channel communication path. The signaling message may be compliant with the network signaling protocol used on the network 108. In some embodiments, the signaling message may include a SIP INFO message or H.323 FACILITY message received by the proxy application 124 from the interworking unit 112.

During 322, the interworking unit 114 maps the signaling message received from the proxy application 124 into an application language message. For example, the interworking unit 112 may map the INFO or FACILITY portions of the signaling message into a CSTA or TAPI (Telephone Application Programming Interface) event message.

During 306, the interworking unit 114 provides the application language message to the client application 104.

In some embodiments, the method 320 may include the proxy application 124 receiving the signaling message from the interworking unit 112, the interworking unit 112 mapping an application language message or other data into the signaling message received by the proxy application 124, the interworking unit 112 sending the signaling message, etc.

Other method embodiments also are possible. For example, in some embodiments, a method for passing call control application information within a network signaling path or using a network signaling protocol may include the interworking unit 112 receiving data from the server application 102 indicative of an action involving the client device 111 associated with the network 108; the interworking unit 112 mapping the data into a signaling message compliant with a network signaling protocol used on the network 108; the interworking unit 112 providing the signaling message to the proxy application 124 capable of sending the signaling message via network signaling path; the proxy application 124 providing the signaling message to the interworking unit 114; the interworking unit 114 mapping the signaling message into an application language message; the interworking unit 114 providing the application language message to the client application 104 associated with the client device 111; and the client application 104 processing the application language message.

As another example, in some embodiments, a method for passing call control application information within a network signaling protocol or via a network signaling path may include the interworking unit 114 receiving data from the client application 104; the interworking unit 114 mapping the data into a signaling message; the interworking unit 114 providing the signaling message to the proxy application 124; the proxy application 124 providing the signaling message to the interworking unit 112; the interworking unit 112 mapping the signaling message into an application language message; the interworking unit 112 providing the application language message to the server application 102; and the server application 112 processing the application language message.

Server

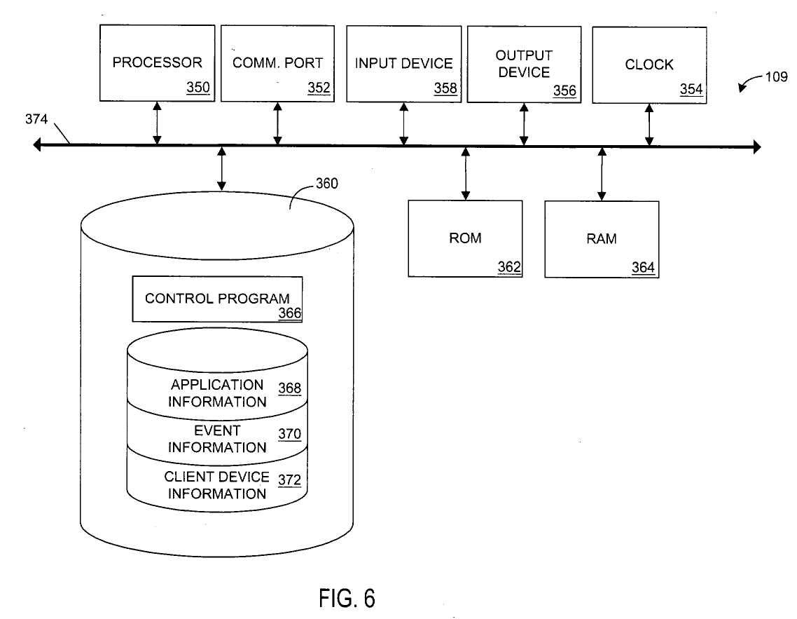

Now referring to FIG. 6, a representative block diagram of a server 109 is illustrated. In some embodiments, the server 109 may be adapted to implement one or more of the elements of the methods disclosed herein. In some embodiments, a client device (e.g., the client device 111) also may include some or all of the components illustrated in FIG. 6.

The server 109 may include a processor, microchip, central processing unit, or computer 350 that is in communication with or otherwise uses or includes one or more communication ports 352 for communicating with user devices and/or other devices. In some embodiments, the processor 350 may be operative to implement one or more elements of the methods disclosed herein. Communication ports may include such things as local area network adapters, wireless communication devices, Bluetooth technology, etc. The server 109 also may include an internal clock element 354 to maintain an accurate time and date for the server 109, create time stamps for communications received or sent by the server 109, etc.

If desired, the server 109 may include one or more output devices 356 such as a printer, infrared or other transmitter, antenna, audio speaker, display screen or monitor, text to speech converter, etc., as well as one or more input devices 358 such as a bar code reader or other optical scanner, infrared or other receiver, antenna, magnetic stripe reader, image scanner, roller ball, touch pad, joystick, touch screen, microphone, computer keyboard, computer mouse, automatic speech recognition, etc.

In addition to the above, the server 109 may include a memory or data storage device 360 to store information, software, databases, communications, device drivers, applications, etc. The memory or data storage device 360 preferably comprises an appropriate combination of magnetic, optical and/or semiconductor memory, and may include, for example, Read-Only Memory (ROM), Random Access Memory (RAM), a tape drive, flash memory, a floppy disk drive, a Zip™ disk drive, a compact disc and/or a hard disk. The server 109 also may include separate ROM 362 and RAM 364.

The processor 350 and the data storage device 360 in the server 109 each may be, for example: (i) located entirely within a single computer or other computing device; or (ii) connected to each other by a remote communication medium, such as a serial port cable, telephone line or radio frequency transceiver. In one embodiment, the server 109 may comprise one or more computers that are connected to a remote server computer for maintaining databases.

A conventional personal computer or workstation with sufficient memory and processing capability may be used as the server 109. In one embodiment, the server 109 operates as or includes a Web server for an Internet environment. The server 109 may be capable of high volume transaction processing, performing a significant number of mathematical calculations in processing communications and database searches. A Pentium™ microprocessor such as the Pentium III™ or IV™ microprocessor, manufactured by Intel Corporation may be used for the processor 350. Equivalent processors are available from Motorola, Inc., AMD, or Sun Microsystems, Inc. The processor 350 also may comprise one or more microprocessors, computers, computer systems, etc.

Software may be resident and operating or operational on the server 109. The software may be stored on the data storage device 360 and may include a control program 366 for operating the server, databases, etc. The control program 366 may control the processor 350. The processor 350 preferably performs instructions of the control program 366, and thereby operates in accordance with the present invention, and particularly in accordance with the methods described in detail herein. The control program 366 may be stored in a compressed, uncompiled and/or encrypted format. The control program 366 furthermore includes program elements that may be necessary, such as an operating system, a database management system and device drivers for allowing the processor 350 to interface with peripheral devices, databases, etc. Appropriate program elements are known to those skilled in the art, and need not be described in detail herein.

The server 109 also may include or store information regarding client devices, alerts, client applications, communications, etc. For example, information regarding one or more applications may be stored in an application information database 368 for use by the server 109 or another device or entity. Information regarding one or more events, actions, etc. may be stored in an event information database 370 for use by the server 109 or another device or entity and information regarding client devices may be stored in a client device information database 372 for use by the server 109 or another device or entity. In some embodiments, some or all of one or more of the databases may be stored or mirrored remotely from the server 109.

In some embodiments, the instructions of the control program may be read into a main memory from another computer-readable medium, such as from the ROM 362 to the RAM 364. Execution of sequences of the instructions in the control program causes the processor 350 to perform the process elements described herein. In alternative embodiments, hard-wired circuitry may be used in place of, or in combination with, software instructions for implementation of some or all of the methods described herein. Thus, embodiments are not limited to any specific combination of hardware and software.

The processor 350, communication port 352, clock 354, output device 356, input device 358, data storage device 360, ROM 362, and RAM 364 may communicate or be connected directly or indirectly in a variety of ways. For example, the processor 350, communication port 352, clock 354, output device 356, input device 358, data storage device 360, ROM 362, and RAM 364 may be connected via a bus 374.

While specific implementations and hardware configurations for servers 109 have been illustrated, it should be noted that other implementations and hardware configurations are possible and that no specific implementation or hardware configuration is needed. Thus, not all of the components illustrated in FIG. 6 may be needed for a server implementing the methods disclosed herein. Therefore, many different types of implementations or hardware configurations can be used in the system 200 and the methods disclosed herein are not limited to any specific hardware configuration.

The methods described herein may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, many, if not all, of the elements for the methods described above are optional or can be combined or performed in one or more alternative orders or sequences without departing from the scope of the embodiments and the claims should not be construed as being limited to any particular order or sequence, unless specifically indicated.

Each of the methods described above can be performed on a single computer, computer system, microprocessor, etc. In addition, two or more of the elements in each of the methods described above could be performed on two or more different computers, computer systems, microprocessors, etc., some or all of which may be locally or remotely configured. The methods can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Although the present invention has been described with respect to various embodiments thereof, those skilled in the art will note that various substitutions may be made to those embodiments described herein without departing from the spirit and scope of the present invention.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

What is claimed is:

1. A method for passing call control application information within a network, comprising:
receiving data from a server application indicative of an action involving a client device associated with a network;
mapping said data into a signaling message compliant with a network signaling protocol used on said network; and
providing said signaling message to a proxy application capable of sending said signaling message via a network signaling path.

2. The method of claim 1, wherein said receiving data from a server application regarding an action involving a client device includes receiving data regarding a communication session being initiated by said server application.

3. The method of claim 1, further comprising:
said proxy application sending said signaling message via a network signaling path to said client device.

4. The method of claim 3, wherein said sending said signaling message via a network signaling path to said client device includes sending said signaling message to an interworking unit associated with said client device.

5. A method for passing call control application information within a network signaling protocol, comprising:
receiving a signaling message from a proxy application, the signaling message being associated with a client device;
mapping the signaling message into an application language message; and
providing said application language message to a server application capable of processing said application language message.

6. The method of claim 5, wherein said receiving a signaling message from a proxy application includes receiving information from said proxy application regarding a session initiation or control event at said client device that is reported to said proxy application.

7. The method of claim 5, wherein client device is part of a network and said signaling message is compliant with a network signaling protocol used on said network.

8. The method of claim 6, wherein said proxy application receives said signaling message via a network signaling path.

9. The method of claim 8, wherein said proxy application receives said signaling message from an interworking unit associated with said client device.

10. A method for passing call control application information within a network signaling protocol, comprising:
receiving a signaling message from a proxy application via a network signaling path;
mapping the signaling message into an application language message; and
providing said application language message to a client application.

11. A method for passing call control application information within a network, comprising:
a first interworking unit receiving data from a server application indicative of an action involving a client device associated with a network, said first interworking unit being associated with said server application;
said first interworking unit mapping the data into a signaling message compliant with a network signaling protocol used on said network;
said first interworking unit providing said signaling message to a proxy application capable of sending said signaling message via network signaling path; and
said proxy application providing said signaling message to a second interworking unit, said second interworking unit being associated with said client device.

12. The method of claim 11, further comprising:
said second interworking unit mapping the signaling message into an application language message; and
said second interworking unit providing said application language message to a client application associated with said client device.

13. A method for passing call control application information within a network signaling protocol, comprising:
a first interworking unit receiving data from a client application;
said first interworking unit mapping said data into a signaling message; and
said first interworking unit providing said signaling message to a proxy application via a network signaling path.

14. The method of claim 13, further comprising:
said proxy application providing said signaling message to a second interworking unit, said second interworking unit being associated with a server application;
said second interworking unit mapping said signaling message into an application language message; and
said second interworking unit providing said application language message to said server application.

15. The method of claim 14, further comprising:
said server application processing said application language message.

16. A system, comprising:
a first interworking unit associated with a server application, said first interworking unit operable to receive data from said server application indicative of an action involving a client device associated with a network, to map the data into a signaling message compliant with a network signaling protocol used on said network; and to provide said signaling message to a proxy application capable of sending said signaling message via network signaling path;
wherein said proxy application is operable to provide said signaling message to a second interworking unit, said second interworking unit being associated with said client device; and
wherein said second interworking unit is operable to map the signaling message into an application language message and to provide said application language to a client application associated with said client device.

17. A system, comprising:
a first interworking unit operable to receive data from a client application; to map said data into a signaling message, and to provide said signaling message to a proxy application; and
wherein said proxy application is operable to provide said signaling message to a second interworking unit via a network signaling path, said second interworking unit being associated with a server application; and
wherein said second interworking unit is operable to map said signaling message into an application language message and to provide said application language message to said server application.

18. A computer program product in a computer readable medium for passing call control information within a network, comprising:
first instructions for obtaining data from a server application indicative of an action involving a client device associated with a network;
second instructions for mapping the data into a signaling message compliant with a network signaling protocol used on said network; and
third instructions for sending said signaling message to a proxy application capable of sending said signaling message via a network signaling path.

19. A computer program product in a computer readable medium for passing call control information within a network, comprising:
first instructions for obtaining receiving data from a client application;
second instructions for mapping said data into a signaling message; and
third instructions for sending said signaling message to a proxy application.
